(19) United States
(12) Patent Application Publication
(10) Pub. No.: US 2025/0116818 A1
(43) Pub. Date: Apr. 10, 2025

(54) PHOTONIC SWITCHES

(71) Applicant: University of Central Florida Research Foundation, Inc., Orlando, FL (US)

(72) Inventor: Ehsan Ordouie

(73) Assignee: University of Central Florida Research Foundation, Inc., Orlando, FL (US)

(21) Appl. No.: 18/906,305

(22) Filed: Oct. 4, 2024

Related U.S. Application Data
(60) Provisional application No. 63/542,904, filed on Oct. 6, 2023.

(51) Int. Cl. G02B 6/35

(52) U.S. Cl. CPC G02B 6/3502; G02B 6/3578

(57) ABSTRACT

A photonic switch system includes an optical chip having an optical input configured to receive an optical signal into the optical chip and an optical output configured to output the optical signal from the optical chip in an ON state. The optical chip defines an optical path from the optical input to the optical output in the ON state. A moveable member is included in the optical path proximate the optical input and a stationary member is included in the optical path proximate the optical output. In the ON state, the optical path runs from the optical input, into the moveable member, through the moveable member, into the stationary member, though the stationary member, and to the optical output. In an OFF state, the optical path diverts away from the optical output.

### CROSS REFERENCE TO RELATED APPLICATIONS

This application claims the benefit of priority to U.S. Provisional Patent Application No. 63/542,904, filed Oct. 6, 2023, the contents of which are incorporated by reference herein in their entirety.

### FIELD

This disclosure relates to photonic switches.

### BACKGROUND

Photonic switches are important components in optical communication systems, biomedical devices, and other applications requiring precise light signal control. Conventional systems have generally been considered satisfactory for their intended purpose. However, there is still a need in the art for improvements. The present disclosure provides a solution for this need.

### SUMMARY

A photonic switch system includes an optical chip including an optical input configured to receive an optical signal into the optical chip and an optical output configured to output the optical signal from the optical chip in an ON state. The optical chip defines an optical path from the optical input to the optical output in the ON state. A moveable member is included in the optical path proximate the optical input and a stationary member is included in the optical path proximate the optical output. In the ON state, the optical path runs from the optical input at a first elevation relative to a substrate of the optical chip, into the moveable member, through the moveable member to a second elevation relative to the substrate, into the stationary member, though the stationary member to the first elevation relative to the substrate, and to the optical output. In an OFF state, the optical path diverts away from the optical output.

The optical output can be a first optical output. The optical path can include a branch. In the OFF state, the optical path can run from the optical input at the first elevation, through a gap between the moveable member and a cap layer that is stationary relative to the substrate at the first elevation, into the branch, and through the branch at the first elevation to the second optical output.

The moveable member can be an optical element configured to move between a first position in the ON state and a second position in the OFF state. The optical element can be a cantilever fixed at a first end relative to the substrate, and moveable relative to the substrate at a second end opposite the first end. The optical element can be of a piezoelectric material configured to relax the cantilever in a first position in an absence of electrical power applied to the piezoelectric material in the OFF state and to deflect to a second position with electrical power applied to the piezoelectric material in the ON state.

Electrodes can be operatively connected to conduct electrical power into the piezoelectric material. The piezoelectric material can include lithium niobate (LN). The electrodes can include gold (Au).

The moveable member can be in a moveable member section of the optical chip that extends from the optical input to an elbow in the optical path. The stationary member can be in a stationary member section of the optical chip that extends from the optical output to the elbow in the optical path. The optical output can be a first optical output, wherein the optical path includes a branch. In the OFF state, the optical path can run from the optical input, through a gap between the moveable member and a cap layer that is stationary relative to the substrate, into the branch, and through the branch to the second optical output, wherein the branch branches from the optical path at the elbow.

In the moveable member section, the optical chip can include a substrate of Silicon (Si), a moveable member layer of Lithium Niobate (LN), a first layer of an air gap between the substrate and the moveable member layer, a cap layer of Silicon Nitride (SiN), and a second layer of the air gap between the cap layer and the moveable member layer. Electrodes of gold (Au) can be on a side of the moveable member layer in the second layer of the air gap. A first end of the moveable member layer can be fixed stationary between a first oxide layer and the substrate and between a second oxide layer and the cap layer. A second end of the moveable member layer can be free to within the air gap between toward and away from the substrate and the cap layer.

In the stationary member section, the optical chip can include the substrate of Silicon (Si), a stationary portion of the moveable member layer, a first oxide layer between the substrate and the stationary portion of the moveable member layer fixing the stationary portion of the moveable member layer to be stationary relative to the substrate, an intermediary layer of SiN, a second oxide layer between the intermediary layer and the cap layer, the cap layer, and a third layer oxide layer between the intermediary layer and the cap layer. The second oxide layer, the intermediary layer, and the third oxide layer can fix the stationary portion of the moveable member layer to be stationary relative to the cap layer and to the substrate.

A method of making a photonic switch includes forming a moveable member in an optical path within an optical chip wafer by removing oxide from around an end of the moveable member in the optical chip wafer to form a cantilever.

Forming the moveable member can include forming a LN-on-insulator (LNOI) wafer including a substrate of Silicon (Si), an oxide layer on the substrate, and a layer of Lithium Niobate (LN) on the oxide layer. The oxide layer can be a portion of the oxide removed from around the end of the moveable member. Forming the moveable member can include forming a tapered region in the layer of LN. The tapered region can form part of the moveable member. Forming the moveable member can include forming gold (Au) electrodes on the tapered region of the moveable member before removing the oxide from around the end of the moveable member. Forming the moveable member can include covering the optical chip wafer with oxide after forming the gold electrodes on the tapered region, and covering the oxide with a layer of silicon nitride (SiN). Forming the moveable member can include etching vias through the SiN layer in order to expose and wet-etch the oxide from around the end of the moveable member. Forming the moveable member can include forming the moveable member proximate an optical input of the photonic chip wafer, and forming a stationary portion of the moveable member by retaining the oxide in a stationary member section of the photonic chip wafer proximate an optical output of an optical path in the photonic chip wafer.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic plan view of an embodiment of a photonic switch constructed in accordance with the present disclosure, showing the moveable section and the stationary section;

FIG. 2a is a schematic cross-sectional front elevation view of a portion of the photonic switch of FIG. 1, showing the moveable member in the OFF state;

FIG. 2b is a schematic cross-sectional side elevation view of a portion of the photonic switch of FIG. 1, showing the optical path in the moveable section in the OFF state;

FIG. 2c is a schematic cross-sectional front elevation view of a portion of the photonic switch of FIG. 1, showing the moveable member in the ON state;

FIG. 2d is a schematic perspective view of the moveable member of FIG. 2c, showing deflection of the moveable member;

FIG. 2e is a schematic side-elevation view of a portion of the photonic switch of FIG. 1, showing the optical path in the moveable section in the ON state, with front elevation cross-sections shown at three locations in the optical path;

FIG. 2f is a schematic cross-sectional side elevation view of a portion of the photonic switch of FIG. 1, showing the wafer layers in the stationary section;

FIG. 2g is a schematic cross-sectional front elevation view of a portion of the photonic switch of FIG. 1, showing the optical path in the stationary section in the ON state, with side elevation cross-sections shown at four locations in the optical path;

FIGS. 3a and 3b are side elevation and top plan views, respectively, of a portion of the photonic switch of FIG. 1, showing a stage in forming the moveable section;

FIGS. 4a and 4b are side elevation and top plan views, respectively, of a portion of the photonic switch of FIG. 1, showing a stage in forming the moveable section after FIGS. 3a and 3b;

FIGS. 5a and 5b are side elevation and top plan views, respectively, of a portion of the photonic switch of FIG. 1, showing a stage in forming the moveable section after FIGS. 4a and 4b;

FIGS. 6a and 6b are side elevation and top plan views, respectively, of a portion of the photonic switch of FIG. 1, showing a stage in forming the moveable section after FIGS. 5a and 5b;

FIGS. 7a and 7b are side elevation and top plan views, respectively, of a portion of the photonic switch of FIG. 1, showing a stage in forming the moveable section after FIGS. 6a and 6b;

FIGS. 8a and 8b are side elevation and top plan views, respectively, of a portion of the photonic switch of FIG. 1, showing a stage in forming the moveable section after FIGS. 7a and 7b; and

FIGS. 9a and 9b are side elevation and top plan views, respectively, of a portion of the photonic switch of FIG. 1, showing a stage in forming the moveable section after FIGS. 8a and 8b.

### DETAILED DESCRIPTION

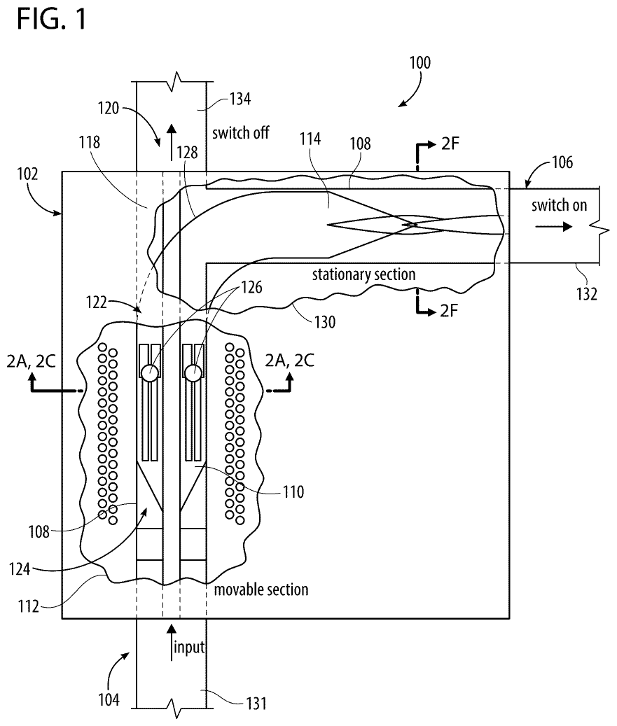

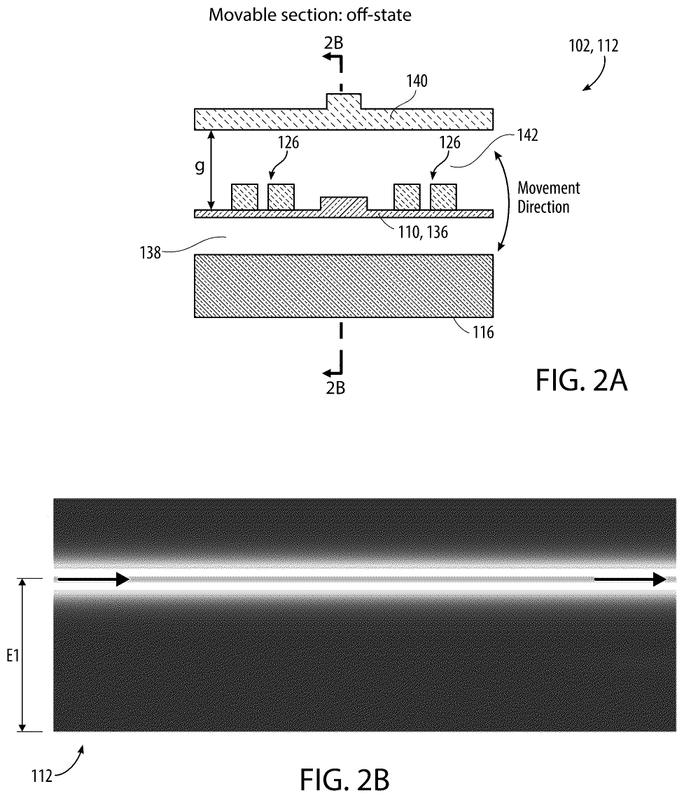

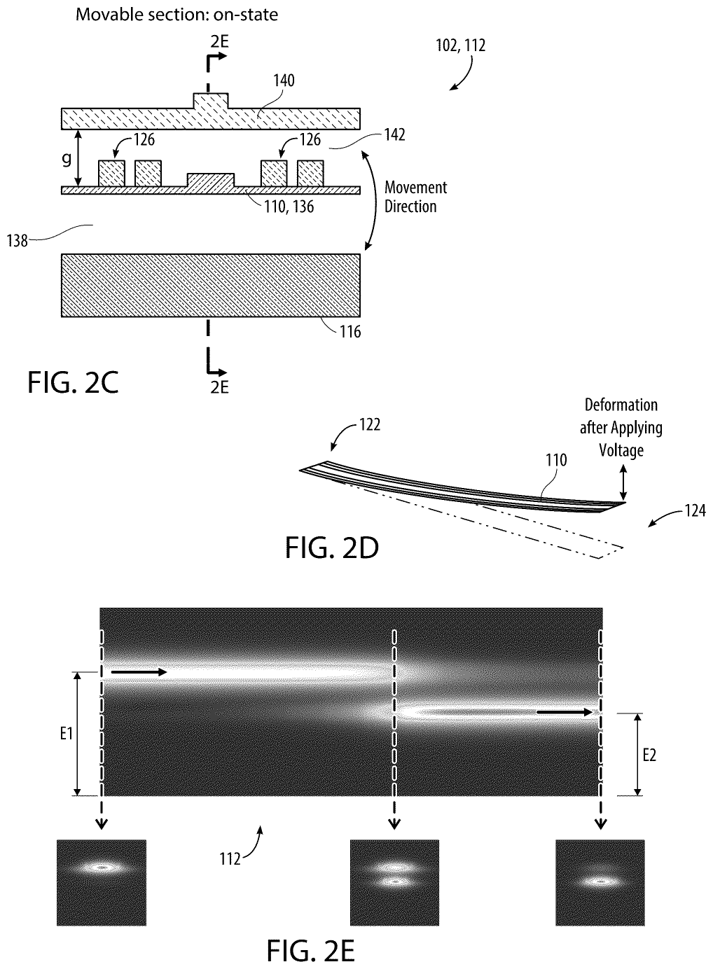

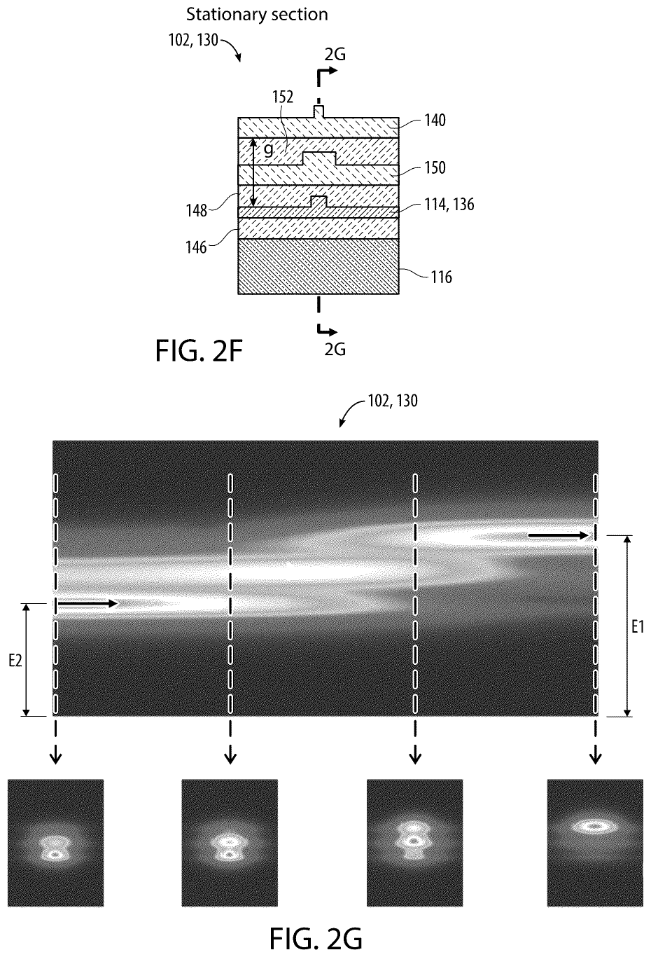

Reference will now be made to the drawings wherein like reference numerals identify similar structural features or aspects of the subject disclosure. For purposes of explanation and illustration, and not limitation, an illustrative view of an embodiment of a photonic switch system in accordance with the disclosure is shown in FIG. 1 and is designated generally by reference character 100. Other views, embodiments, and/or aspects of this disclosure are illustrated in FIGS. 2a-9b.

The photonic switch system 100 includes an optical chip 102 including an optical input 104 configured to receive an optical signal into the optical chip 102 and an optical output 106 configured to output the optical signal from the optical chip 102 in an ON state. The optical chip 102 defines an optical path 108 from the optical input 104 to the optical output 106 in the ON state. A moveable member 110 is included in the optical path 108 proximate the optical input 104 in a moveable section 112 of the optical chip 102. A stationary member 114, e.g. a stationary portion of the same layer as the moveable member 110, is included in the optical path 108 proximate the optical output 106. In the ON state, the optical path 108 runs from the optical input 104 at a first elevation E1 (labeled in FIGS. 2e and 2g) relative to a substrate 116 (labeled in FIGS. 2c and 2f) of the optical chip 102, into the moveable member 110, through the moveable member 110 to a second elevation E2 (labeled in FIGS. 2e and 2g) relative to the substrate 116, into the stationary member 114, though the stationary member 114 to the first elevation E1 relative to the substrate 116, and to the optical output 106. In an OFF state, the optical path 108 diverts away from the optical output 106.

The optical output 106 is a first optical output for the ON state. The optical path 108 includes a branch 118 to a second optical output 120. In the OFF state, the optical path 108 runs from the optical input 104 at the first elevation E1 (labeled in FIGS. 2e and 2g), through a gap g (labeled in FIGS. 2a and 2c) between the moveable member 110 and the cap layer 140 at the first elevation E1, into the branch 118, and through the branch 118 at the first elevation E1 to the second optical output 120. The cap layer 140 is stationary relative to the substrate 116.

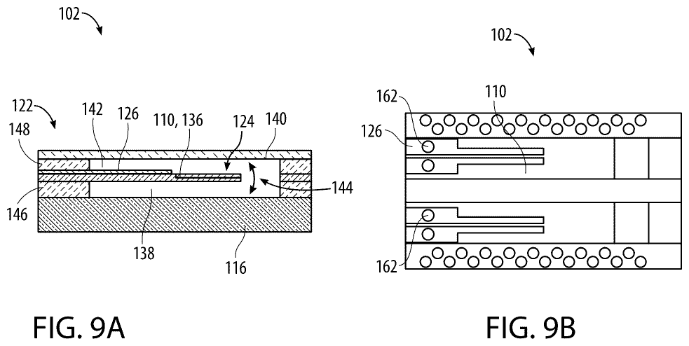

The moveable member 110 is an optical element configured to move between a first position in the ON state (as shown in FIG. 2c) and a second position in the OFF state (as shown in FIG. 2a). The optical element of the moveable member 110 is a cantilever fixed at a first end 122 relative to the substrate 116 (labeled in FIG. 9a), and moveable relative to the substrate 116 at a second end 124 opposite the first end 122. The optical element of the moveable member 110 is of a piezoelectric material, Lithium Niobate (LN), configured to relax the cantilever in a first position of FIG. 2a in absence of electrical power applied to the piezoelectric material in the OFF state and to deflect to a second position of FIG. 2c with electrical power applied to the piezoelectric material in the ON state. FIG. 2d indicates the cantilever deflection of the moveable member 110. Electrodes 126 are operatively connected to conduct electrical power into the piezoelectric material. The electrodes can include gold (Au).

The moveable member 110 is in the moveable member section 112 of the optical chip 102 that extends from the optical input 104 to an elbow 128 in the optical path 108. The stationary member 114 is in a stationary member section 130 of the optical chip 102 that extends from the optical output 106 to the elbow 128 in the optical path 108. The branch 118 of the optical path 108 branches from the optical path 108 at the elbow 128. In the OFF state, the optical path 108 runs from the optical input 104, through a gap g (labeled in FIGS. 2a and 2c) between the moveable member 110 and the cap layer 140, into the branch 118, and through the branch 118 to the second optical output 120. As shown in FIG. 2b, in the OFF state, the optical path 108 is at the first elevation E1 all the way from the optical input 104 to the optical output 120 (labeled in FIG. 1). An input waveguide 131 can be optically coupled to the optical input 104, and respective output waveguides 132, 134 can be optically coupled to the optical output 106 and or the optical output 120. Electrical signals applied to the electrodes 126 determine whether an optical signal is conveyed from the input waveguide 131 to the waveguide 132 or else to the waveguide 134, e.g. if both waveguides 132, 134 are included).

With reference now to FIGS. 2a and 2c, in the moveable member section 112, the optical chip 102 includes the substrate 116, which can be of Silicon (Si), a moveable member layer 136, a first layer 138 of an air gap 144 (labeled in FIG. 9a) between the substrate 116 and the moveable member layer 136, a cap layer 140, e.g., of Silicon Nitride (SiN), and a second layer 142 of the air gap 144 between the cap layer 140 and the moveable member layer 136. The electrodes 126 are on a side of the moveable member layer 136 in the second layer 142 of the air gap 144 (labeled in FIG. 9a). As shown in FIG. 9a, the first end 122 of the moveable member layer 136 is fixed stationary between a first oxide layer 146, which is fixed to the substrate 116, and a second oxide layer 148, which is fixed to the cap layer 140. A second end of the moveable member layer 136 is free to within the air gap 144 between toward and away from the substrate 116 and the cap layer 140.

With reference now to FIGS. 2f and 2g, in the stationary member section 130, the optical chip 102 includes the substrate 116, a stationary member 114 formed of a portion of the moveable member layer 136, the first oxide layer 146 between the substrate 116 and the stationary portion 114 of the moveable member layer 136 fixing the stationary portion 114 of the moveable member layer 136 to be stationary relative to the substrate 116, an intermediary layer 150, e.g., of SiN, the second oxide layer 148 between the intermediary layer 150 and the cap layer 140, the cap layer 140, and a third layer oxide layer 152 between the intermediary layer 150 and the cap layer 140. The second oxide layer 148, the intermediary layer 150, and the third oxide layer 152 fix the stationary portion 114 of the moveable member layer 136 to be stationary relative to the cap layer 140 and to the substrate 116.

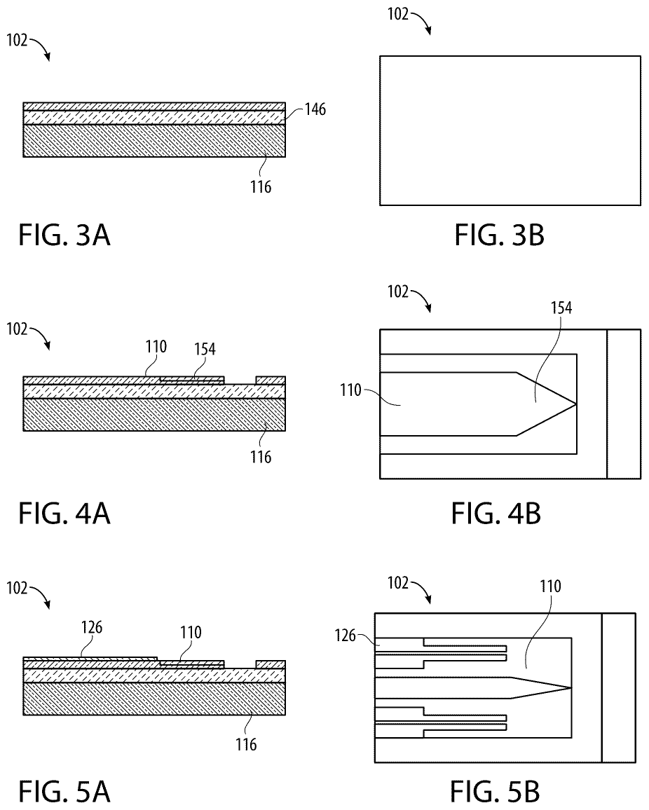

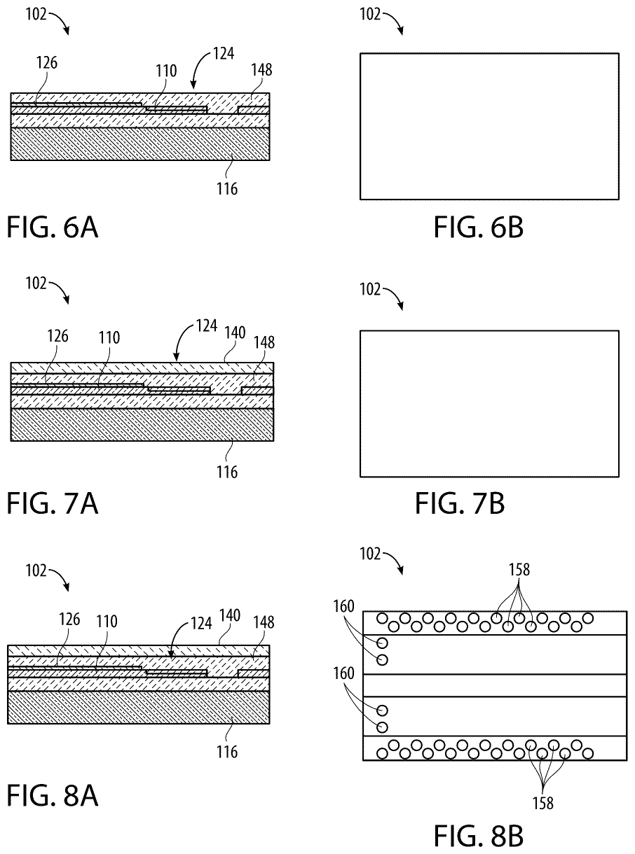

With reference now to FIGS. 3a and 3b, a method of making a photonic switch includes forming a wafer, e.g., a LN-on-insulator (LNOI) wafer, including a substrate 116, e.g., of Silicon (Si), a first oxide layer 146, e.g., of Silicon Dioxide, on the substrate 116, and a layer 136, e.g., of Lithium Niobate (LN), on the oxide layer 146. The oxide layer 146 is a portion of the oxide that is eventually removed from around the end of the moveable member 110. As shown in FIGS. 4a and 4b, the method includes forming a tapered region 154 in the layer 136. The tapered region 154 eventually forms part of the moveable member 110. As shown in FIGS. 5a and 5b, the method includes forming the electrodes 126 on the tapered region 154 of the moveable member 110. As shown in FIGS. 6a and 6b, the method includes covering the wafer of the optical chip 102, including the electrodes 126, with another layer 148, which in the region of the end 124 of the moveable member 110 joins the first layer 146 of oxide. As shown in FIGS. 7a and 7b, the method includes covering the oxide layer 148 with a cap layer, e.g., of silicon nitride (SiN). As shown in FIGS. 8a and 8b, the method includes etching vias 158 through the cap layer 140 in order to expose and wet-etch the oxide from around the end 124 of the moveable member as shown in FIGS. 9a and 9b, forming the moveable member 110 in the optical path 108 (labeled in FIG. 1) within the optical chip wafer to form a cantilever. As shown in FIG. 1, the moveable member 110 is formed proximate an optical input 104, and the stationary portion 130 of the moveable member layer 136 is formed by retaining the oxide in the stationary member section 130 of the photonic chip 102 proximate the optical output 106. The method includes depositing a conductor 162 such as gold (Au), labeled in FIG. 9b, in some of the vias 160, labeled in FIG. 8b, for electrical connection of an external power source to the gold electrodes on the moveable member.

Certain embodiments can include a bonding-free thin-film lithium niobate (TFLN) micro electromechanical systems (MEMS) photonic switch with a broad spectral bandwidth from visible to IR. In certain embodiments, the device is based on a cantilever coupler structure utilizing the piezoelectric capability of lithium niobate and also provides a wider spectral range than existing switches. In certain embodiments, the switch can exhibit an excellent ON/OFF extinction ratio and large isolation between ports, making it a high-performance alternative to other photonic switches. Additionally, in certain embodiments, the switch benefits from the bonding-free fabrication process, which simplifies manufacturing, reduces device costs, and eliminates the need for bonding steps, an advantage over TFLN cantilever-based photonic switches.

In certain embodiments, the thin-film lithium niobate platform enables the integration of other thin-film lithium niobate-based devices on the same chip, making it a promising technology for large-scale integrated switches. In certain embodiments, the highly scalable design of the switch allows light to pass through only one switching element regardless of size, simplifying the design and improving reliability.

MEMS photonic switches can be essential components in optical communication systems, biomedical devices, and a variety of applications requiring precise control of light signals. Certain embodiments include a bonding-free thin-film lithium niobate MEMS photonic switch that offers a broad spectral bandwidth, ranging from the visible to infrared spectrum. In certain embodiments, the device incorporates a cantilever coupler structure that takes advantage of lithium niobate's extensive transparency window, resulting in a wider spectral range compared to existing switches. In certain embodiments, the switch boasts an outstanding ON/OFF extinction ratio and substantial isolation between ports, establishing it as a superior alternative to other photonic switches.

Furthermore, the bonding-free fabrication process simplifies manufacturing, reduces device costs, and eliminates the need for bonding steps, providing lower cost over conventional thin-film lithium niobate (TFLN) cantilever-based photonic switches. In certain embodiments, the thin-film lithium niobate platform enables the integration of additional thin-film lithium niobate-based devices on the same chip, making it an ideal technology for large-scale photonic integrated circuits (PICs). The highly scalable design ensures that light passes through only one switching element regardless of size, streamlining the design and improving reliability.

In certain embodiments, the piezoelectric effect can be utilized to implement the switching mechanism. The piezoelectric effect is a versatile electro-mechanical transduction process that operates in both directions. In certain embodiments, Lithium niobate (LN) is used as the piezoelectric material due to its high piezoelectric coefficient, which allows for significant and rapid mechanical deflections (a few microns within sub-microseconds) upon the application of electrical voltages.

In certain embodiments, e.g., as illustrated in the movable section of FIG. 1, two sets of metallic electrodes are positioned on top of the slab section of the lithium niobate waveguide. When voltage is applied to the LN cantilever, the piezoelectric film either expands or contracts within its plane because of piezoelectricity. As a result, the beam deflects. Upon voltage withdrawal, the piezoelectric beam's elasticity causes the deflection to revert, and the switch returns to the off-state. FIG. 1 depicts the top view of an embodiment of a switch, with the incoming optical mode situated within the top silicon nitride (Si₃N₄, SiN) layer. The cantilever switch is located beneath the SiN layer, and as demonstrated in FIG. 2(a), a gap (g) separates the LN cantilever switch and the SiN waveguide. In the absence of applied voltage, the switch stays in the off state, and a suitably designed gap size prevents any coupling between the SiN and LN waveguides. Consequently, in the off-state (FIG. 2(b)), the optical mode remains in the SiN layer, and no switching occurs.

When voltage is applied to the switch, out-of-plane deformation transpires (FIG. 2(d)), and the optical mode couples from the SiN waveguide to the TFLN layer (FIG. 2(g)). It is crucial to note that the input of the LN waveguide is tapered to enable smoother transitions. In this case, as shown in FIG. 2(f), the output of the switch in the on state consists of an intermediary SiN layer, tapered at both ends to ensure a smooth transition of the optical mode from the TFLN waveguide to the top SIN waveguide. Additionally, as shown in FIG. 1, the stationary section of the switch includes tapered LN and top SiN waveguides, further facilitating the transition of the optical mode between the different layers.

An embodiment of a potential fabrication process for the movable section of the device is illustrated and analyzed in FIGS. 3 through 9. A notable innovation of the proposed concept is the elimination of TFLN bonding requirements, allowing for the fabrication of the device using standard processes. It is essential to note that the stationary section of the switch features an intermediary SiN layer, which is not present in the movable section and is not depicted in the fabrication steps. This distinction between the stationary and movable sections highlights the unique design approach taken to optimize the switch's performance and maintain ease of fabrication.

An embodiment of the potential fabrication process for the movable section of the device is illustrated and analyzed in FIGS. 3a through 9b. The side- and top-view cross-sections focus on the fabrication-wise position of the beginning of the tapered region close to the input, as shown in FIG. 1. The processing begins with a standard LN-on-insulator (or LNOI) wafer in FIGS. 3a and 3b. It is followed by forming the tapered region (FIGS. 4a and 4b) and Au electrodes (FIGS. 5a and 5b). The whole wafer is then covered with oxide (SiO2) (FIGS. 6a and 6b) and silicon nitride (SiN) (FIGS. 7a and 7b) thin films. FIGS. 8a and 8b show how vias are etched through the SiN layer in order to expose and wet-etch the underneath oxide and conclude the processing with LN membranes, i.e., the moveable member (FIGS. 9a and 9b) for micro-electromechanical systems (MEMS) action.

In conclusion, the proposed bonding-free TFLN MEMS photonic switch presents a groundbreaking solution for various applications requiring precise light signal control. Its exceptional performance characteristics, such as the ON/OFF extinction ratio and isolation between ports, and its innovative design and fabrication process make it a promising candidate for widespread adoption in optical communication systems, biomedical devices, augmented reality (AR), virtual reality (VR), mixed reality (MR), and other emerging applications. The switch's compatibility with large-scale photonic integrated circuits further reinforces its potential for enabling the development of next generation optical systems and devices across a broad range of industries, including telecommunications and advanced computing.

Embodiments can provide a bonding-free fabrication process. A bonding-free process simplifies manufacturing, reduces device costs, and eliminates the need for bonding steps, which is a critical advantage over TFLN cantilever based photonic switches. Embodiments can provide a wide spectral range. Certain embodiments of a switch can offer an ultra-broad spectral wavelength range of operation (400 nm to 5 um) compared to existing photonic switches, making it suitable for a wider range of applications. Embodiments can provide integration with other devices. The thin-film lithium niobate platform of embodiments of the device enables the integration of other thin-film lithium niobate-based devices on the same chip, enhancing its versatility and applicability. Embodiments can provide scalability. The highly scalable design of embodiments of the switch allows light to pass through only one switching element regardless of size, simplifying the design and improving reliability, making it a promising technology for large-scale integrated switches. Embodiments can provide high-performance characteristics. Embodiments of the switch exhibits an excellent ON/OFF extinction ratio and large isolation between ports, making it a high-performance alternative to other photonic switches. Embodiments can provide low power consumption. For example, embodiments of the switch can have a cantilever coupler structure that allows for efficient light coupling and reduces power consumption compared to other photonic switches. Embodiments can provide a small form factor. For example, embodiments of the device's thin-film design and highly scalable architecture enable the creation of compact and space-efficient photonic circuits.

Embodiments can provide compatibility with existing technology. Embodiments of the switch can be easily integrated into existing optical communication systems and can be used in conjunction with other technologies such as silicon photonics. Embodiments can provide potential for high-speed operation. Embodiments of the switch's cantilever coupler structure allows for fast switching times, making it a promising technology for high-speed data transmission and optical interconnects. Embodiments can provide reduced environmental impact. A bonding-free fabrication process used to make embodiments of the device reduces waste and environmental impact compared to traditional bonding-based processes.

Certain embodiments can be used for optical communication systems. For example, a bonding-free thin-film lithium niobate MEMS photonic switch can be used in optical communication systems for efficient and precise control of light signals. Certain embodiments can be used in biomedical devices, e.g., optical sensing and imaging systems which require high-performance photonic switches with a broad spectral range of operation. Certain embodiments can be used in data centers. For example, in certain embodiments, the switch's scalability, low power consumption, and high-speed operation make it a promising technology for use in data centers for high-speed data transmission and optical interconnects. Certain embodiments can be used in AR/VR technology. In certain embodiments, the switch's broad spectral range and bonding-free fabrication process can be beneficial in AR/VR technology where it can be used to control light signals for display and sensing applications in the visible range. Certain embodiments can be used in aerospace and defense. For example, in certain embodiments, the switch's small form factor, low power consumption, and high performance characteristics make it suitable for use in aerospace and defense applications such as optical communication systems, sensors, and imaging. Certain embodiments can be used in quantum technology. In certain embodiments, the switch's wide spectral range and scalability make it a promising technology for use in quantum technology applications such as quantum communication and quantum computing. Certain embodiments can be used in manufacturing and industrial applications. In certain embodiments, the switch's precise control of light signals can be useful in manufacturing and industrial applications such as sensing and measurement systems.

Certain embodiments can be used in automotive and transportation. In certain embodiments, the switch's small form factor, low power consumption, and high performance characteristics make it suitable for use in automotive and transportation applications such as LiDAR systems for autonomous driving. Certain embodiments can be used in energy. In certain embodiments, the switch's precise control of light signals can be useful in energy applications such as solar panels, where it can help improve efficiency and optimize energy production. Certain embodiments can be use in scientific research. In certain embodiments, the switch can also be used in scientific research applications such as microscopy and spectroscopy, where precise control of light signals is essential.

Embodiments of this disclosure include a cantilever coupler and a vertical adiabatic coupler, which are heterogeneously integrated with a silicon nitride (SiN) platform, and a bonding-free thin-film lithium niobate (TFLN) platform. Unlike traditional structures based on the silicon photonic platform, embodiments offer a broad spectral bandwidth from visible to IR, making it highly versatile and applicable to a wider range of applications. Embodiments can allow for a highly scalable design that simplifies the switch design and improves reliability. Embodiments can include a TFLN coupler integrated with the SiN platform which provides a promising technology for large-scale integrated switches. Embodiments of this disclosure also include a fabrication process that eliminates the need for bonding steps, making it easier to fabricate, environmentally friendly, and cost effective.

Furthermore, a thin-film lithium niobate platform enables the integration of other TFLN based devices on the same chip, allowing for the creation of network-on-a-chip systems. The bonding-free thin-film lithium niobate MEMS photonic switch can have commercial applications in a wide range of fields. The switch's ability to provide efficient and precise control of light signals over a broad spectral range could make it a valuable component in optical communication systems, biomedical devices, quantum computing, AR/VR technology, and more.

Embodiments can provide improved photonic switches that are less expensive to manufacture, more reliable, and can operate over a wider spectral range. The highly scalable design of embodiments of the switch could also make it a promising technology for large-scale integrated switches. Embodiments can make a significant impact in multiple industries by providing a solution for efficient and precise light signal control.

The following references are incorporated by reference herein in their entirety.
[1] Wood, Michael, Peng Sun, and Ronald M. Reano. “Compact cantilever couplers for low-loss fiber coupling to silicon photonic integrated circuits.” Optics express 20.1 (2012): 164-172.
[2] Chen, Long, et al. “Low-loss and broadband cantilever couplers between standard cleaved fibers and high-index-contrast Si₃N₄ or Si waveguides.” IEEE Photonics Technology Letters 22.23 (2010): 1744-1746.
[3] Sun, Peng, and Ronald M. Reano. “Cantilever couplers for intra-chip coupling to silicon photonic integrated circuits.” Optics express 17.6 (2009): 4565-4574.
[4] Seok, Tae Joon, et al. “Large-scale broadband digital silicon photonic switches with vertical adiabatic couplers.” Optica 3.1 (2016): 64-70.

In ref. [1], the paper discusses the use of compact and low-loss cantilever couplers for coupling light from tapered optical fibers to silicon strip waveguides. The length of the embedded silicon inverse-width taper is minimized, and simulations show that the quadratic taper exhibits the lowest coupling loss. In ref. [2], this article presents a novel design for a broadband fiber coupler that allows efficient coupling from standard cleaved fibers to waveguides on a silicon substrate. The design uses a cantilevered glass waveguide with an index-matching material around the cantilever and requires no additional deposition or lithography steps beyond those already used for regular waveguide chips. This coupler design is simple to fabricate and has good performance, making it useful for the development of silicon-based photonics. In ref. [3], this paper describes a new method for connecting optical fibers to silicon photonic circuits within a chip. The method uses cantilevers made of silicon dioxide and silicon strips that are deflected out of plane by residual stress and allow direct access to the devices on the entire chip surface without dicing or cleaving. The proposed method is suitable for both butt-coupling from tapered fibers and collimation-coupling from lensed fibers with large conical angles. In ref. [4], the paper presents a 64×64 digital silicon photonic switch, which is a large monolithic switch and silicon photonic integrated circuit. The switch has low on-chip insertion loss, broadband operation, fast switching time, and high extinction ratio. The switch uses a passive matrix architecture with MEMS-actuated adiabatic couplers, which provide high ON/OFF ratios and no loss in the OFF state. The authors suggest that the switch can be scaled to several hundred ports with reduced losses through improved design and fabrication processes.

Embodiments can include any suitable computer hardware and/or software module(s) to perform any suitable function (e.g., as disclosed hereinabove, e.g., for any suitable application of one or more embodiments of this disclosure). As will be appreciated by those skilled in the art, aspects of the present disclosure may be embodied as a system, method or computer program product. Accordingly, aspects of this disclosure may take the form of an entirely hardware embodiment, an entirely software embodiment (including firmware, resident software, micro-code, etc.), or an embodiment combining software and hardware aspects, all possibilities of which can be referred to herein as a “circuit,” “module,” or “system.” A “circuit,” “module,” or “system” can include one or more portions of one or more separate physical hardware and/or software components that can together perform the disclosed function of the “circuit,” “module,” or “system”, or a “circuit,” “module,” or “system” can be a single self-contained unit (e.g., of hardware and/or software). Furthermore, aspects of this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of this disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of this disclosure may be described above with reference to flowchart illustrations and/or block diagrams of methods, apparatus (systems) and computer program products according to embodiments of this disclosure. It will be understood that each block of any flowchart illustrations and/or block diagrams, and combinations of blocks in any flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in any flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

What is claimed is:

1. A photonic switch system comprising:
an optical chip including an optical input configured to receive an optical signal into the optical chip and an optical output configured to output the optical signal from the optical chip in an ON state;
wherein the optical chip defines an optical path from the optical input to the optical output in the ON state, wherein a moveable member is included in the optical path proximate the optical input and a stationary member is included in the optical path proximate the optical output;
wherein in the ON state, the optical path runs from the optical input at a first elevation relative to a substrate of the optical chip, into the moveable member, through the moveable member to a second elevation relative to the substrate, into the stationary member, though the stationary member to the first elevation relative to the substrate, and to the optical output; and
wherein in an OFF state, the optical path diverts away from the optical output.

2. The system as recited in claim 1, wherein the optical output is a first optical output, wherein the optical path includes a branch, wherein in the OFF state, the optical path runs from the optical input at the first elevation, through a gap between the moveable member and a cap layer that is stationary relative to the substrate at the first elevation, into the branch, and through the branch at the first elevation to the second optical output.

3. The system as recited in claim 2, wherein the moveable member is an optical element configured to move between a first position in the ON state and a second position in the OFF state.

4. The system as recited in claim 3, wherein the optical element is a cantilever fixed at a first end relative to the substrate, and moveable relative to the substrate at a second end opposite the first end.

5. The system as recited in claim 4, wherein the optical element is of a piezoelectric material configured to relax the cantilever in a first position in an absence of electrical power applied to the piezoelectric material in the OFF state and to deflect to a second position with electrical power applied to the piezoelectric material in the ON state.

6. The system as recited in claim 5, further comprising electrodes operatively connected to conduct electrical power into the piezoelectric material.

7. The system as recited in claim 6, wherein the piezoelectric material includes lithium niobate (LN), and wherein the electrodes include gold (Au).

8. The system as recited in claim 1, wherein the moveable member is in a moveable member section of the optical chip that extends from the optical input to an elbow in the optical path.

9. The system as recited in claim 8, wherein the stationary member is in a stationary member section of the optical chip that extends from the optical output to the elbow in the optical path.

10. The system as recited in claim 9, wherein the optical output is a first optical output, wherein the optical path includes a branch, wherein in the OFF state, the optical path runs from the optical input, through a gap between the moveable member and a cap layer that is stationary relative to the substrate, into the branch, and through the branch to the second optical output, wherein the branch branches from the optical path at the elbow.

11. The system as recited in claim 9, wherein in the moveable member section, the optical chip includes:
a substrate of Silicon (Si);
a moveable member layer of Lithium Niobate (LN);
a first layer of an air gap between the substrate and the moveable member layer;
a cap layer of Silicon Nitride (SiN); and
a second layer of the air gap between the cap layer and the moveable member layer, wherein electrodes of gold (Au) are on a side of the moveable member layer in the second layer of the air gap.

12. The system as recited in claim 11, wherein a first end of the moveable member layer is fixed stationary between a first oxide layer and the substrate and between a second oxide layer and the cap layer, and wherein a second end of the moveable member layer is free to within the air gap between toward and away from the substrate and the cap layer.

13. The system as recited in claim 11, wherein in the stationary member section, the optical chip includes:
the substrate of Silicon (Si);
a stationary portion of the moveable member layer;
a first oxide layer between the substrate and the stationary portion of the moveable member layer, fixing the stationary portion of the moveable member layer to be stationary relative to the substrate;
an intermediary layer of SiN;
a second oxide layer between the intermediary layer and the cap layer;
the cap layer; and
a third layer oxide layer between the intermediary layer and the cap layer, wherein the second oxide layer, the intermediary layer, and the third oxide layer fix the stationary portion of the moveable member layer to be stationary relative to the cap layer and to the substrate.

14. A method of making a photonic switch comprising:
forming a moveable member in an optical path within an optical chip wafer by removing oxide from around an end of the moveable member in the optical chip wafer to form a cantilever.

15. The method as recited in claim 14, wherein forming the moveable member includes forming a LN-on-insulator (LNOI) wafer including a substrate of Silicon (Si), an oxide layer on the substrate, and a layer of Lithium Niobate (LN) on the oxide layer, wherein the oxide layer is a portion of the oxide removed from around the end of the moveable member.

16. The method as recited in claim 15, wherein forming the moveable member includes forming a tapered region in the layer of LN, wherein the tapered region forms part of the moveable member.

17. The method as recited in claim 15, wherein forming the moveable member includes forming gold (Au) electrodes on the tapered region of the moveable member before removing the oxide from around the end of the moveable member.

18. The method as recited in claim 17, wherein forming the moveable member includes:
covering the optical chip wafer with oxide after forming the gold electrodes on the tapered region; and
covering the oxide with a layer of silicon nitride (SiN).

19. The method as recited in claim 18, wherein forming the moveable member includes etching vias through the SiN layer in order to expose and wet-etch the oxide from around the end of the moveable member.

20. The method as recited in claim 18, wherein forming the moveable member includes:
forming the moveable member proximate an optical input of the photonic chip wafer; and
forming a stationary portion of the moveable member by retaining the oxide in a stationary member section of the photonic chip wafer proximate an optical output of an optical path in the photonic chip wafer.
